(19) United States
(12) Patent Application Publication
(10) Pub. No.: US 2019/0317196 A1
(43) Pub. Date: Oct. 17, 2019

(54) CROSSTALK MITIGATION CIRCUIT FOR LIDAR PIXEL RECEIVERS

(71) Applicant: Continental Automotive Systems, Inc., Auburn Hills, MI (US)

(72) Inventors: Martin Denham, Bend, OR (US); Patrick B. Gilliland, Santa Barbara, CA (US); Barton M. Goldstein, Santa Barbara, CA (US); Osman Musa, Santa Barbara, CA (US)

(73) Assignee: Continental Automotive Systems, Inc., Auburn Hills, MI (US)

(21) Appl. No.: 16/386,792

(22) Filed: Apr. 17, 2019

Related U.S. Application Data
(60) Provisional application No. 62/658,622, filed on Apr. 17, 2018.

(51) Int. Cl. G01S 7/486; G01S 17/10; G01S 7/481

(52) U.S. Cl. CPC G01S 7/4861; G01S 7/4816; G01S 17/10

(57) ABSTRACT

An apparatus for reducing crosstalk between cathodes of detector diodes of an imager detector array includes a capacitor and voltage switch coupled into a detector bias network to virtually isolate a detector diode from a common cathode power plane while simultaneously ‘powering’ the diode for image acquisition, e.g., photo current detection. A method includes a timing sequence wherein during non-acquisition time intervals, the capacitor is charged through the voltage switch by turning the switch on to allow charge to flow into the capacitor from a common supply plane. The method further includes disconnecting the capacitor before an acquisition timer interval such that during the acquisition time interval, the current through the detector diode, caused by incident flux, comes from the capacitor and not from the common cathode power plane.

### CROSS REFERENCE TO RELATED APPLICATION

This application claims the benefit of provisional patent application No. 62/658,622, filed Apr. 17, 2018, which is hereby incorporated by reference.

### TECHNICAL FIELD

The technical field relates to the field of CMOS integrated circuits (“ICs”) and also to the field of optical sensors, and in particular Lidar sensors that measure time of flight (“TOF”) of laser pulses.

### BACKGROUND

Electrical and optical crosstalk are major concerns for Lidar sensors and in particular, for high-speed flash Lidar (“HFL”) two-dimensional array type sensors which perform a three-dimensional spatial acquisition simultaneously for all pixels. The major effect of concern is that a Lidar receiver CMOS read out integrated circuit (“ROIC”) must be sensitive to 5 to 6 orders of magnitudes of incident in-band flux.

In order to detect distant targets, pixel receiver circuits must be sensitive to extremely low pixel detector currents. Simultaneously, nearby pixels may be experiencing extremely high flux from “retro-reflectors” (designed for high reflectivity) which could also be close to the sensor.

Since a two-dimensional array is limited by the inherent physics of chip manufacturing and circuit realization, the high-flux returns may cause disturbances in the power and ground planes of the receiver, due primarily to resistance. Correspondingly, the highly sensitive pixel circuits some distance away may pick up the supply disturbance and translate the disturbance into false returns. Furthermore, in that there is a time delay between the source disturbance and the nearby pixel amplifiers, it can also create ghost images delayed in time.

Of particular concern is these supply disturbances can cause real image artifacts to experience additional time delays, causing range errors in measurements. All of these effects are highly undesirable and threaten the usefulness of the devices.

### BRIEF SUMMARY

In one exemplary embodiment, a circuit for a light detection system, includes an optical detector diode having a cathode and an anode. The circuit also includes a switch electrically connected between the cathode of the optical detector diode and an electrical supply. A pixel receiver circuit is electrically connected to the anode of the optical detector diode. The circuit further includes a capacitor electrically connected to the cathode of the detector diode and a ground potential of the pixel receiver circuit.

In one exemplary embodiment, a method for operating a circuit of a light detector system is provided. The circuit includes an optical detector diode having a cathode and an anode, a switch electrically connected between the cathode of the optical detector diode and an electrical supply, a pixel receiver circuit electrically connected to the anode of the optical detector diode, and a capacitor electrically connected to the cathode of the detector diode and a ground potential of the pixel receiver circuit. The method includes charging the capacitor during a non-acquisition period to a bias voltage of the optical detector diode. The method further includes isolating the capacitor from the electrical supply prior to an acquisition period by opening the switch.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 is a block diagram of a lidar sensor assembly according to one exemplary embodiment;

FIG. 2 is an electrical schematic diagram of an optical receiver circuit of the lidar sensor assembly according to one exemplary embodiment; and

FIG. 3 is an electrical schematic diagram of an optical receiver circuit according to the prior art.

### DETAILED DESCRIPTION

Referring to the Figures, wherein like numerals indicate like parts throughout the several views, a lidar sensor assembly 100 is shown and described herein.

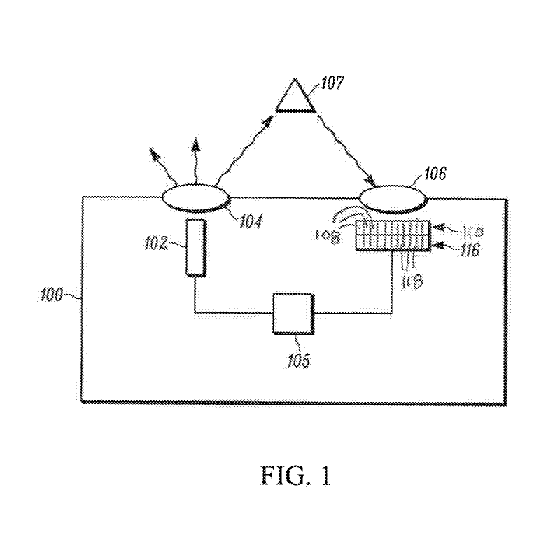

Referring to FIG. 1, the lidar sensor assembly 100 of the exemplary embodiment includes a light source 102. In the exemplary embodiment, the light source 102 includes a laser transmitter (not separately shown) configured to produce a pulsed laser light output. The laser transmitter may be a solid-state laser, monoblock laser, semiconductor laser, fiber laser, and/or an array of semiconductor lasers. It may also employ more than one individual laser. The pulsed laser light output, in the exemplary embodiment, has a wavelength in the infrared range. However, it should be appreciated that other wavelengths of light may be produced.

The lidar sensor assembly 100 may also include a diffusion optic 104 to diffuse the pulsed laser light output produced by the light source 102. The diffused, pulsed laser light output of the exemplary embodiment allows for the lidar sensor assembly 100 to operate without moving, e.g., rotating, the light source 102, as is often typical in prior art lidar sensors.

The lidar sensor assembly 100 may also include a controller 105 in communication with the light source 102. The controller 105 may include a microprocessor and/or other circuitry capable of performing calculations, manipulating data, and/or executing instructions (i.e., running a program). The controller 105 in the exemplary embodiment controls operation of the light source 102 to produce the pulsed laser light output.

The lidar sensor assembly 100 of the exemplary embodiment also includes a receiving optic 106, e.g., a lens (not separately numbered). Light produced by the light source 102 may reflect off one or more objects 107 and is received by the receiving optic 106. The receiving optic 106 focuses the received light into a focal plane. The focal plane is coincident with a plurality of light sensitive detectors 108. Each light sensitive detector 108 is each associated with a pixel (not shown) of an image (not shown).

The light sensitive detectors 108 may be arranged into one or more detector arrays 110. The light sensitive detectors 108 of each detector array 110 may be arranged into a plurality of rows (not shown) and columns (not shown), thus providing a generally rectangular shape. However, it should be appreciated that the detector array 110 may include any number of light sensitive detectors 108 and be arranged in other shapes and configurations.

Each light sensitive detector 108 is configured to receive light produced by the light source 102 and reflected from at least one of the objects 107, as shown in FIG. 1. Each light sensitive detector 108 is also configured to produce an electrical signal in response to receiving the reflected light. The detectors 108 may be formed in a thin film of indium gallium arsenide (“InGaAs”) (not shown) deposited epitaxially atop an indium phosphide (“InP”) semiconducting substrate (not separately numbered). However, the detectors 108 may be formed of other suitable materials, e.g., InSb, HgCdTe, silicon, SiGe, etc.

At least one readout integrated circuit (“ROIC”) 116 is bonded to the detector array 110 as shown in FIG. 1. The ROIC 116 is formed with a silicon substrate (not separately numbered) but may be formed in gallium arsenide, indium phosphide, silicon germanium, silicon nitride, gallium nitride, or other wafer circuit technology. The ROIC 116 includes a plurality of unit cell electronic circuits (hereafter “unit cells” or “unit cell”) 118. In the exemplary embodiment, each unit cell 118 is associated with one of the light sensitive detectors 108 and receives the electrical signal generated by the associated light sensitive detector 108. Each unit cell 118 is configured to amplify the signal received from the associated light sensitive detector 102 and sample the amplified output. The unit cell 118 may also be configured to detect the presence of an electrical pulse in the amplified output associated with a light pulse reflected from the object 107. Of course, each unit cell 118 may be configured to perform functions other than those described above or herein. The unit cells 118 of the exemplary embodiment are arranged into a plurality of rows (not shown) and columns (not shown). This second wafer circuit is typically a silicon circuit,

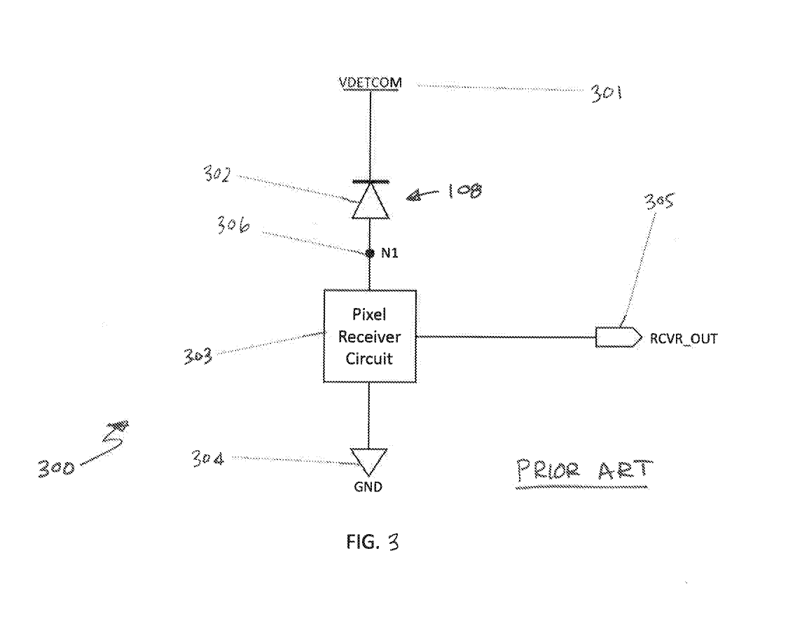

FIG. 3 shows a prior art implementation of an optical receiver circuit 300 for one pixel of a lidar sensor assembly 100. Such an implementation could be monolithic (e.g., backside illuminated CMOS) or a hybrid assembly, such as that described with reference to FIG. 1 above, where an array 110 of detectors 108 is affixed to the ROIC 116.

In FIG. 3, the detector 108 is represented as a diode 302 having an anode (not labeled) and a cathode (not labeled). Node VDETCOM 301 represents a positive power plane to which the array 110 of cathodes of detector diodes 302 is coupled. The anode of diode 302 is coupled to node 306 which in turn is coupled to a receiver circuit 303 which could be any one of a number of topologies, including, for instance, a transimpedence amplifer (“TIA”) which is one very common Lidar implementation amplifier circuit. The receiver circuit 303 includes an output 305 for driving a ‘downstream’ circuit network (not shown) which may be designed and used to determine the amplitude and delay of a laser pulse return. It is self-evident however, that the invention is not limited to Lidar but could benefit staring arrays and other imager types, and could be applied to virtually any wavelength of incident light. The pixel receiver circuit 303 is also coupled to a low reference, perhaps ground 304.

Of course, it will obvious to those skilled in the art that any component in circuit 300 could be of other types and polarities, including that diode 302 could be forward biased in some degree and its cathode and anode connections reversed. Such changes would not comprise new art and are covered by this description.

It has been determined that the positive supply at the detector diode 302 cathode connections (e.g., InGaAs detectors) is a very sensitive supply plane. The detector 108 substrate itself is connected to a most-positive-supply rail (for example, 5V to 8V) and comprises low resistivity doped material. The conundrum is that low resistance is desired for optimal operation; however, in as much as the resistance is non-trivial, a large amount of flux in a specific location will cause instantaneous lateral debiasing of nearby detectors 108 due to the, albeit minimal, resistance. It is this instantaneous debiasing, through the self-capacitance of the detector 108 causes small injections of coupling current which appear to the pixel receiver circuit 303 as the equivalent of low-current reflection from a distant target 107. In some cases, the false signal can look like a negative target return. Even if a filter were in place to correct for a negative target return, such a negative response could in fact cancel the return from a real target 107.

One issue with prior art circuit 300 is that the cathode connection of all detectors 108 in the array 110 of detectors 108 are tied together to form a common node 301. Such a configuration suffers from non-ideal and non-trivial sheet resistance of the physical implementation of this node 301. Upon reception of high flux incident at diode 302, the photo-induced current will travel through node VDETCOM 301, usually laterally through the common supply plane of non-trivial resistance. As current travels through this plane of non-trivial resistance, lateral voltage debiasing occurs in two dimensions. The level of this debiasing is a product of the current density through the supply plane and the non-trivial resistance in the supply plane. This debiasing, or deflection in the supply plane causes an instantaneous, high frequency change in the cathode potential of neighboring detectors 108 that are not receiving the same high flux. Since these detectors 108 comprise PN junctions having non-trivial parasitic capacitance (e.g., 100 to 300 FF), the instantaneous voltage change induced by the lateral current couples into the receivers 303 associated with these neighboring detectors 108. This coupled voltage appears identical to a signal, either a positive signal (i.e., a false return) or negative signal (i.e., a canceling return), depending on the type of pixel receiver circuit 103. Both effects are undesirable.

Almost any and every effort to lower the resistance of this supply plane, increase supply plane capacitance or reduce detector capacitance, address the problem in a marginal way, making modest but insufficient improvements to this problem. Furthermore, such improvements in the detector array 110 manufacturing come at high cost and complexity, and there is a reluctance for the detector array material vendors to engage in these types of solutions.

Post detection circuit fixes and other strategies have only improved the problem in a matter of degrees, but ultimately still fall short of desired performance goals.

In order to truly improve this problem, it is desired to eliminate the low resistivity top-side connection altogether and create a completely isolated common cathode detector diode connection with associated resupply strategy that completely isolates all detector diodes 302 from one another during an acquisition cycle. This will allow for truly independent, uncoupled, optical pulse detection and conversion to electrical pulse signals.

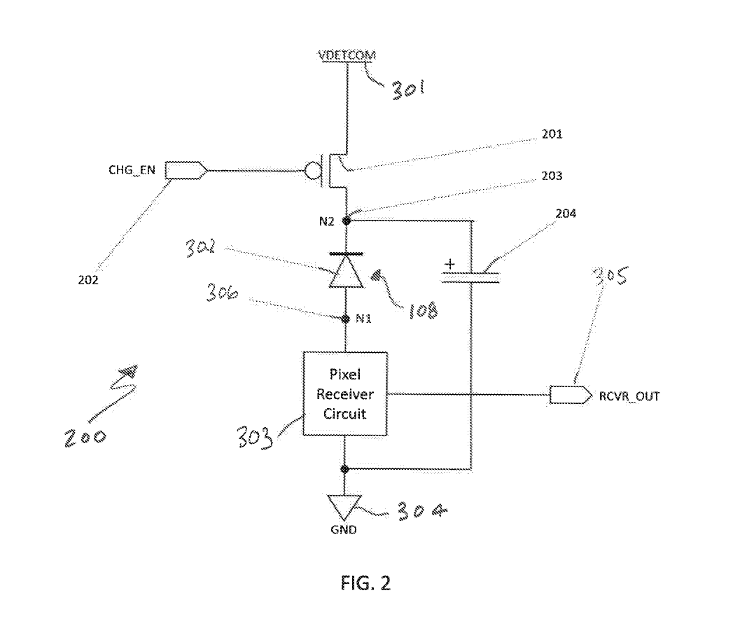

Consider now the circuit 200 in FIG. 2. A transistor 201 is electrically connected between VDETCOM 301 and a node N2 203. A gate (not numbered) of transistor 201 is connected to a control signal CHG_EN 202. The control signal CHG_EN 202 may be generated by a control circuit, e.g., by the controller 105. In this configuration, CHG_EN 202 may have a high potential to electrically disconnect VDETCOM 301 and node N2 203 or to a low potential to electrically connect VDETCOM 301 to node N2 203 and thus creates the ability to charge node N2 203 or isolate node N2 203. In the embodiment shown in FIG. 2, a capacitor 204 is connected to node N2 203 and local ground potential 304.

In one embodiment, prior to the acquisition of a time of flight (“TOF”) signal, perhaps caused by strobing the laser light source 102, the control signal CHG_EN 202 is taken to a low potential, causing the transistor 201 to charge the capacitor 204. The capacitor 204 is of reasonable size to bias the diode 302 for an acquisition event. Said another way, the capacitor is charged to a bias voltage of the optical detector diode 302 during a non-acquisition period. The acquisition cycle considers potential reverse bias transport saturation current, often called “dark current” in imagers. In one embodiment, capacitor 204 is 15 pico-Farads, and the dark current of the diode 302 is in the range of 20 nanoamperes (nA).

After charging and prior to an acquisition, CHG_EN signal 202 is taken to a high potential, isolating the node N2 203 and leaving a voltage on N2 equal to the total charge on the capacitor 204 divided by the value of capacitance of the capacitor 204. Said another way, the capacitor 204 is isolated from the electrical supply 301 prior to an acquisition period by opening the switch 201. Dark current through the diode 302 will slowly drain the charge on capacitor 204, but an acquisition event is substantially short so as to not negatively influence the circuit 200.

Upon receipt of a nominal return pulse (perhaps between 100 nA and 100 uA) and of sufficiently short duration (perhaps between 3 nsec and 10 nsec, measured at its half amplitude), some amount of charge is extracted from the capacitor 204, but the voltage of N2 203, and thus back-bias of diode 302, remains essentially the same.

Upon receipt of a very high flux signal pulse (perhaps 1 mA to 10 mA) of similar duration, some amount of charge is extracted from capacitor 204, but the voltage of N2 203 remains only slightly less after the event, perhaps even down to some critical back-bias potential, but the diode remains still adequately biased and is thus still able to service additional nominal return pulses, if such pulses will happen in a given acquisition cycle for that pixel.

Upon receipt of an excessively high signal pulse (perhaps greater than 10 mA), again of similar time duration, a large amount of charge is extracted from capacitor 204, and perhaps now capacitor 204 will be depleted such that the diode 302 is no longer adequately biased and is unable to generate meaningful current for subsequent return pulses.

In all three cases (above), key advantages are provided relative to prior art circuit 300. Most notably, circuit 200 isolates the cathode of a pixel diode such that high flux current no longer comes from common supply plane 301, but from capacitor 204, and thus the invention prevents debiasing of supply plane 301. In this manner, the invention prevents disturbance of supply plane 301.

In addition to preventing a pixel from coupling debiasing voltage deflections into the supply plane 301, the disclosed circuit 200 and method also protects a neighboring pixel from receiving any supply plane disturbance by decoupling it from supply plane 301, essentially isolating it from any voltage deflections on supply plane 301.

Another advantage is that the capacitor 204 is large enough to allow for both high flux returns and multiple returns, both of which are common in LIDAR applications. Modest amounts of flux, causing modest amounts of signal currents from diode 302 to pixel receiver circuit 303 do not de-bias net N2 and thus net N2 remains capable of keeping diode 302 in an optimal bias.

Yet another advantage of the invention is that dynamic range is improved because the distance from capacitor 204 to diode 302 is ideally very short and thus connection resistance between them is negligible. Such negligible resistance is capable of supplying fast transient current, allowing for the full reproduction of current pulses converted from peak optical signal flux events. This beneficial performance advantage results in further improvements to the signal-to-noise ratio (“SNR”) of the circuit.

It should be appreciated that there are numerous ways to implement a switch between VDETCOM 301 and node N2 203 and can include transistor 201 but could also or likewise include other transistor types and circuits (e.g., P and N transfer gate).

Capacitor 204 could be implemented any number of ways, including metal finger caps, MOM caps, MIM caps, gate caps (including NFET gate caps), or any combination of these.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. A circuit for a light detection system, comprising:
an optical detector diode having a cathode and an anode;
a switch electrically connected between the cathode of the optical detector diode and an electrical supply;
a pixel receiver circuit electrically connected to the anode of the optical detector diode; and
a capacitor electrically connected to the cathode of the detector diode and a ground potential of the pixel receiver circuit.

2. The apparatus as set forth in claim 1, wherein the switch is a PMOS transistor with a gate coupled to a control circuit to receive a control signal.

3. The apparatus as set forth in claim 2, wherein the control signal is configurable to allow the PMOS transistor to connect or disconnect the cathode of the first detector diode from the electrical supply.

4. The apparatus as set forth in claim 3, wherein the control signal is configurable to charge the capacitor to a bias voltage of the optical detector diode during a non-acquisition period.

5. The apparatus as set forth in claim 4, wherein the control signal is configurable to isolate the capacitor from the electrical supply prior to an acquisition period by opening the switch.

6. A method for operating a circuit of a light detector system, the circuit including an optical detector diode having a cathode and an anode, a switch electrically connected between the cathode of the optical detector diode and an electrical supply, a pixel receiver circuit electrically connected to the anode of the optical detector diode, and a capacitor electrically connected to the cathode of the detector diode and a ground potential of the pixel receiver circuit, said method comprising:
charging the capacitor during a non-acquisition period to a bias voltage of the optical detector diode; and
isolating the capacitor from the electrical supply prior to an acquisition period by opening the switch.
